(19) United States
(12) Patent Application Publication
(10) Pub. No.: US 2012/0256614 A1
(43) Pub. Date: Oct. 11, 2012

(54) TECHNIQUE FOR LIMITING FAULT CURRENT TRANSMISSION

(75) Inventors: Frank Sinclair, Quincy, MA (US); Rajesh Dorai, Cupertino, CA (US)

(73) Assignee: VARIAN SEMICONDUCTOR EQUIPMENT ASSOCIATES, INC., Gloucester, MA (US)

(21) Appl. No.: 13/399,658

(22) Filed: Feb. 17, 2012

Related U.S. Application Data
(60) Provisional application No. 61/444,371, filed on Feb. 18, 2011.

(51) Int. Cl. H02H 9/02; H01F 38/00; H01F 27/28; H01F 17/04; H01F 27/24; B82Y 15/00

(52) U.S. Cl. 323/355; 336/221; 336/218; 336/170; 977/932

(57) ABSTRACT

A technique for limiting fault current transmission is disclosed. In one particular exemplary embodiment, the technique may be realized with a fault current limiter comprising a core having at least first easy axis and a hard axis; and a first coil wound around the core, the first coil configured to carry current. In some embodiment, the easy axis of the core may be aligned with H fields generated by the current transmitted through the first coil.

### PRIORITY

This application claims priority to U.S. Provisional Patent Application Ser. No. 61/444,371, filed on Feb. 18, 2011, entitled “Inductive Fault Current Limiter With Nanoparticle Core.” The entire specification of U.S. Provisional Patent Application Ser. No. 61/444,371, is incorporated herein by reference.

### FIELD

Present disclosure relates to transmitting/distributing current, more particularly to a technique for limiting transmission of fault current.

### BACKGROUND

Fault current is generally defined as a temporary and substantial surge in the current transmitted along the power transmission/distribution network. The fault current may be caused by any number of events, including lightning strike, downed power lines, or catastrophic failure of one or more components in the power transmission/distribution network which results in localized grounding of the network. When such an event occurs, a large load appears. The network, in response, may deliver a large amount of current or the fault current to this load. This fault current may exceed the capacity of some of the components in the network and destroy the components. One way to minimize the effect of the fault current is to incorporate a fault current limiter (FCL), which may limit the transmission of the fault current. Ideally, the fault current limiter is fast acting, responding within a few milliseconds of the fault condition. In addition, the current limiter should be self-resetting, allowing normal current to be transmitted after the fault condition subsides.

Examples of FCL may include circuit breakers or fuses. During fault condition, the circuit breaker mechanically opens the network and disrupts further fault current transmission. This system, although effective, may not be fast acting, nor is it self-resetting. In particular, there are significant limits to how fast a circuit breaker can open. In the presence of an inductive load, an arc will develop between the contacts and continue to carry current even after the components are not in contact. Also, the circuit breaker must be closed after the fault condition subsides. If fuses are used, the fuses may have to be replaced manually.

Another example of the fault current limiter is a superconducting fault current limiter (SCFCL). Generally, SCFCL contains a superconducting circuit which is maintained below critical temperature level T_{c}, critical magnetic field level H_{c}, and critical current level I_{c}. During normal operation, SCFCL exhibits almost zero resistivity allowing normal current to be transmitted through the network. During fault condition, at least one of the circuit temperature, the magnetic field applied to the circuit, and the current being transmitted through the circuit is raised above the critical level, and the superconducting circuit is quenched. As a result, the resistance of the circuit and the SCFCL surges, and transmission of the fault current may be limited. SCFCL is desirable as the system is fast acting and self-resetting after the fault condition.

One disadvantage of SCFCL may be in the requirement that the superconducting circuit be maintained at a temperature around 77° K or below. As such, a reliable cryogenic system, which may have complex design, is needed. If the cryogenic system fails during non-fault condition, the SCFCL may introduce additional impedance in the network, and SCFCL may be highly inefficient.

Yet another example of the conventional FCL is an inductive fault current limiter (IFCL) 100 shown in FIG. 1. The conventional IFCL 100 may comprise first and second steel cores 102a and 102b, an AC circuit 104, and a superconducting circuit 106. As shown in the figure, The AC circuit 104 is wound around the outer limbs of the first and second cores 102a and 102b. Moreover, the superconducting circuit 106 is wound around the inner limb of each core 102a and 102b. Generally, the first and second cores 102a and 102b may be made out of steel or other saturable magnetic materials.

In operation, AC current is transmitted through AC circuit 104. At the same time, DC current flow through the superconducting circuit 106 that is wound around the inner limb of the first and second cores 102a and 102b. During normal condition, DC current flowing through the superconducting circuit 106 maintains the cores 102a and 102b at magnetic saturation, and minimum inductance will be exhibited by the AC circuit 104. During fault condition, the fault current flowing through the AC circuit 104 takes the cores 102a and 102b out of magnetic saturation. As a result the AC circuit may exhibit large inductance opposing further increase of the AC current flowing through the AC circuit. In the process, transmission of the fault current flowing through the AC circuit 104, hence the IFCL 100, may be reduced.

The conventional IFCL 100 has several disadvantages. Much like the conventional SCFCL system described above, the conventional IFCL 100 requires complex cryogenic system to maintain the superconducting circuit 106 at temperature around 77° K or below. In addition, the IFCL 100 described above has a large footprint.

Thus, a fault current limiter that is fast acting, highly reliable, self-resetting, smaller footprint that can handle normal operating currents in excess of 1 kA may be needed.

### SUMMARY

A technique for limiting fault current transmission is disclosed. In one particular exemplary embodiment, the technique may be realized with a fault current limiter comprising a core having at least first easy axis and a hard axis; and a first coil wound around the core, the first coil configured to carry current.

In accordance with other aspects of this particular exemplary embodiment, the core may comprise a plurality of nanoparticles having at least first easy axis and a hard axis, wherein the at least first easy axis of the core may be defined by alignment of the at least first easy axis of the plurality of nanoparticles.

In accordance with further aspects of this particular exemplary embodiment, the plurality of nanoparticles may be nano-grains having shape anisotropy.

In accordance with additional aspects of this particular exemplary embodiment, the plurality of nanoparticles may have ellipsoid shape.

In accordance with further aspects of this particular exemplary embodiment, the plurality of nanoparticles may be nano-crystals having crystal anisotropy.

In accordance with additional aspects of this particular exemplary embodiment, the easy axis of the core may be aligned with H fields generated by the current transmitted through the first coil.

In accordance with further aspects of this particular exemplary embodiment, the easy axis of the core is oriented at right angle to H fields generated by the current transmitted through the first coil.

In accordance with additional aspects of this particular exemplary embodiment, the fault current limiter may further comprise an inductor; a capacitor electrically connected to the inductor in series; and a resistor, where the coil may be electrically connected to the resistor in series and where the coil may be electrically connected to the capacitor in parallel.

In accordance with other aspects of this particular exemplary embodiment, the core may have an open end configuration.

In accordance with further aspects of this particular exemplary embodiment, the core may have a closed loop configuration.

In accordance with additional aspects of this particular exemplary embodiment, the core may be a toroidal core.

In accordance with further aspects of this particular exemplary embodiment, the coil may be wound uniformly around substantially entire the toroidal core.

In accordance with additional aspects of this particular exemplary embodiment, the core may contain at least one of iron (Fe), silicon (Si), copper (Cu), niobium (Nb), cobalt (Co), nickel (Ni), and palladium (Pd) and platinum (Pt).

In accordance with further aspects of this particular exemplary embodiment, the fault current limiter may further comprise second and third coils wound around the core, where each of the first, second, and third coil is perpendicular relationship with one another.

In accordance with additional aspects of this particular exemplary embodiment, the first coil is configured to carry a first AC current, wherein the second coil is configured carry a second AC current that is 120° out of phase with the first AC current, and wherein the third coil is configured to carry a third AC current that is 120° out of phase with the first and second AC current.

In accordance with other aspects of this particular exemplary embodiment, the core may further comprise a second easy axis.

In accordance with another exemplary embodiment, the technique may be realized with a fault current limiter comprising a core comprising a plurality of nanoparticles having at least first easy axis and a hard axis, where the plurality of the nanoparticles may be aligned to define at least first easy axis and a hard axis of the core; and a coil wound around the core, the coil configured to transmit AC current from a first end one end of the coil to a second end of the coil, wherein the easy axis of the core is aligned with H fields generated by the AC current transmitted through the coil and applied to the core.

In accordance with other aspects of this particular exemplary embodiment, the core may have an open end configuration.

In accordance with further aspects of this particular exemplary embodiment, the core may have a closed loop configuration.

In accordance with additional aspects of this particular exemplary embodiment, the plurality of nanoparticles may be nano-grains having shape anisotropy, and where the plurality of nanoparticles have ellipsoid shape.

In accordance with further aspects of this particular exemplary embodiment, the plurality of nanoparticles may have nano-crystals having crystal anisotropy.

In accordance with another exemplary embodiment, the technique for limiting fault current transmission may be realized as a method comprising transmitting current through a coil wound around a core, wherein the core exhibit at least one easy axis and a hard axis defined by alignment of plurality of nanoparticles contained therein; and aligning the at least one easy axis of the core with H fields generated by current transmitted through the coil and applied to the core.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 depicts a conventional IFCL used for limiting fault current transmission.

FIG. 2 depicts an exemplary IFCL according to one embodiment of the present disclosure.

FIG. 3 depicts a comparison of B-H characteristic of an ideal core and non-ideal core of the IFCL shown in FIG. 2.

FIG. 4 depicts another exemplary IFCL according to another embodiment of the present disclosure.

FIG. 5 depicts calculation used to determine the volume of the core shown in FIG. 4.

FIGS. 6a and 6b depict an exemplary LC resonant IFCL according to another embodiment of the present disclosure.

FIG. 7 depicts B-H characteristic of a core of the LC resonant IFCL shown in FIGS. 6a and 6b.

FIG. 8 depicts a comparison of B-H characteristics of the core of the LC resonant IFCL shown in FIGS. 6a and 6b and the core of conventional LC resonant IFCL.

FIG. 9 depicts another exemplary inductive fault current limiter according to another embodiment of the present disclosure.

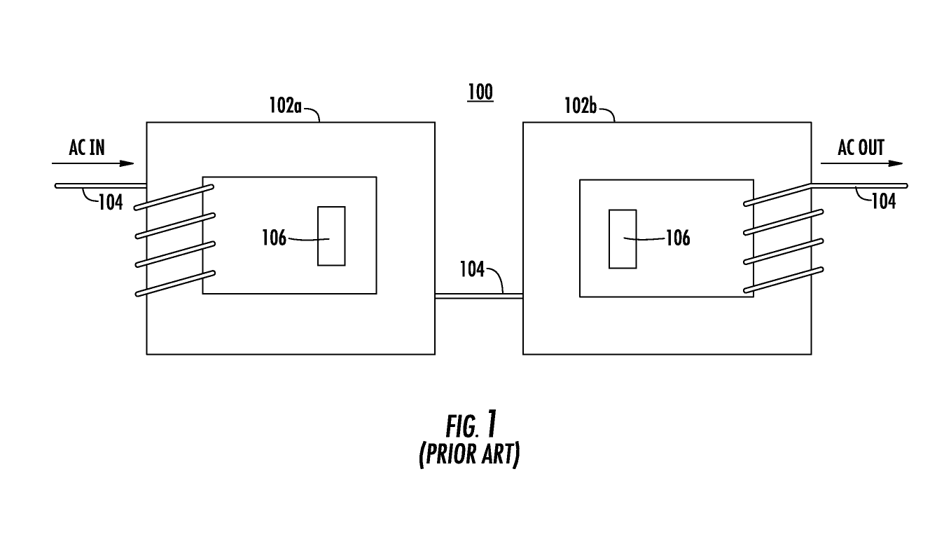

### DETAILED DESCRIPTION

Herein novel techniques for limiting transmission of fault current are disclosed. For clarity and simplicity, the present disclosure may focus on the inductive fault current limiter comprising a core. The core may comprise a plurality of nanoparticles. Those of ordinary skill in art will recognize that the embodiments included in the present disclosure are for illustrative purpose only. For example, the present disclosure may focus on, among others, cores having particular geometry, and made with particular material. Those skilled in the art should recognize that such properties are disclosed for the purpose of clarity and simplicity. Other, for example, geometry or material may also be included in the scope of the present disclosure. In addition, the nanoparticles may refer either nanograins or nanocrystals.

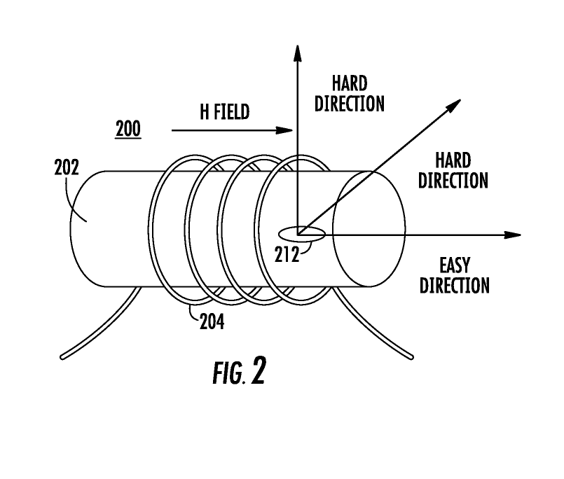

Referring to FIG. 2, there are shown an IFCL 200 according to one embodiment of the present disclosure. In the present embodiment, IFCL 200 may comprise, among others, a core 202 and a coil 204 wound around the core 202. AC current may be transmitted from one end to another end of the coil 204. Those of the art should recognize that IFCL 200 may contain additional cores to accommodate different phases of the AC current. However, only one of the cores is shown for clarity and simplicity. Unlike the cores 102a and 102b of conventional IFCL 100, the core 202 in the IFCL 200 of the present embodiment may have an open core configuration with, for example, a cylindrical geometry. However, the present disclosure does not preclude core having other configurations (e.g. a closed-loop configuration) and/or other geometries (e.g. rectangular geometry).

Various materials may be used for the core 202. However, the material of the core 202 may preferably be a ferromagnetic material having high permeability (μ) at high magnetizing force (H). Examples of such a material may include a material containing at least one of iron (Fe), silicon (Si), copper (Cu), niobium (Nb), cobalt (Co), nickel (Ni), and palladium (Pd), platinum (Pt), or a combination thereof. Specific examples of the material in the core 202 may include CoPd or FePt based alloys. Those in the art will recognize that the list is not exhaustive and other materials may also be used.

The core 202 may comprise a plurality of nanoparticles 212, one of which is shown in FIG. 2. In the present disclosure, the nanoparticles 212 may be too small to support domain walls. In addition, the nanoparticles 212 in the core 202 may exhibit magnetic anisotropy. For example, the nanoparticles may have at least one easy axis, along which each nanoparticle 212 is easily magnetized. The nanoparticles 212 may optionally contain hard axis, as shown in FIG. 2. Although the nanoparticles 212 in the present embodiment may have one easy axis and two hard axes, those of ordinary skill in the art will recognize that the nanoparticles 212, in other embodiments, may have different easy/hard axes configuration. For example, the nanoparticles in other embodiments may have two easy axes and one hard axis.

One example of the nanoparticles 212 having one easy axis may be nano-grains having ellipsoid or prolate shape, where the grains are easily magnetized along the elongated axis. Such nanoparticles 212 may be known as having shape anisotropy. In the present disclosure, the nanoparticles 212 with shape anisotropy may be prepared using, for example, a surfactant-assisted ball milling process. Another example of the nanoparticles 212 having one easy axis may be nano-crystals having one or more preferential directions for the spins of the electrons. Such nanoparticles 212 may be known as having crystal anisotropy. Specific examples of the nanoparticles 212 having crystal anisotropy may include cobalt alloys having hexagonal symmetry with easy axis along the six-fold direction or iron compounds such as FePt that have an easy axis along the tetragonal symmetry direction in the crystal.

In the present disclosure, the nanoparticles 212 in the core 202 may be aligned such that the core 202 also exhibit magnetic anisotropy that corresponds to the magnetic anisotropy of the aligned nanoparticles 212. For example, the nanoparticles 212 having one easy axis and two hard axes may be aligned such that the core 202 may also have one easy axis and two hard axes. Such a core 202 may be different from the conventional core 102 that includes a plurality of grains or crystals sufficiently large and capable of supporting domain walls. In addition, the grains or crystals in the conventional core 102 may not have magnetic anisotropy. Further, even if the grains or crystals in the conventional core 102 have magnetic anisotropy, the grains or crystals in the conventional core 102 may be randomly oriented. As such, the core 102 may not have a well defined easy axis and/or hard axis.

In the present embodiment, the nanoparticles 212, hence the core 202, may be oriented such that the easy axis of nanoparticles 212 or the core 202 is aligned (0°) with the magnetizing (H) fields generated by the AC current transmitted through coil 204 and applied to the core 202.

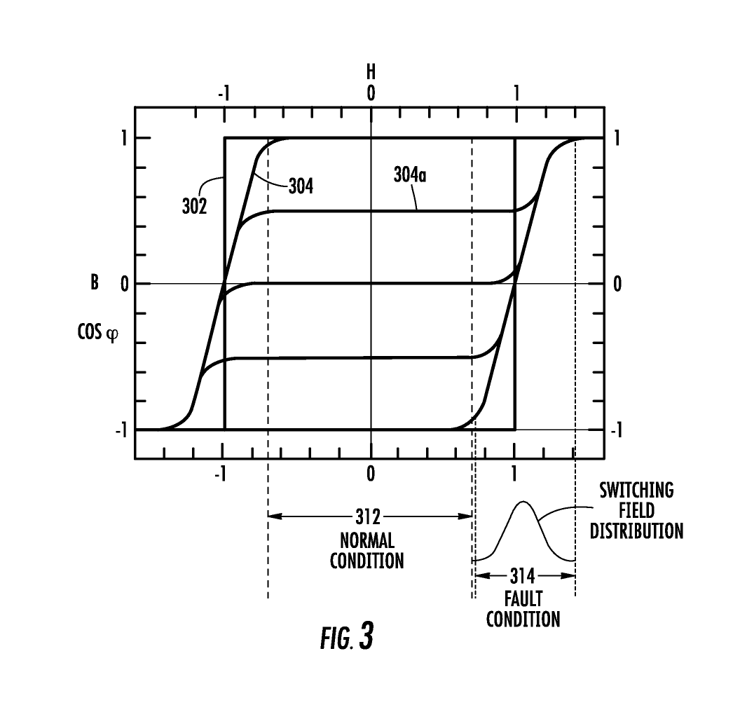

Preferably, the nanoparticles 212 in the core 202 are uniform with respect to size and orientation. In addition, minimal magnetic spin exchange interactions among neighboring nanoparticles 212 are preferred. The core 202 with such nanoparticles 212 may exhibit hysteresis or B-H characteristic that is close to an ideal core. As shown by a first B-H curve 302 shown in FIG. 3, an ideal core with easy axis aligned (0°) with the magnetizing (H) field may exhibit a square hysteresis loop. Such a core may exhibit low permeability until the H-field applied to the reaches a critical value, at which time the magnetic (B) field abruptly increases to a high value and then saturates, showing a ferromagnetic behavior. However, a core with nanoparticles that vary in size, alignment, and the orientation, or much interaction among neighboring nanoparticles, the hysteresis loop of the core may have a broader hysteresis loop with finite range of switching field and more gradual transition from saturation and non-saturation, as illustrated by a second B-H curve 304. Further, minor hysteresis curves 304a may be observed if the core starts from some incomplete magnetization (e.g. at B=0, H=0). In the present embodiment, the core 202 comprising the nanoparticles 212 that are preferably uniform in size and orientation and that with minimal magnetic interactions may exhibit hysteresis or B-H characteristic that is close to an ideal core.

In operation, AC current is transmitted through the IFCL 200 via the coil 204 wound around the core 202. During normal condition, the core 202 is maintained in a region where B is substantially independent of H shown by arrow 312 of FIG. 3. H fields generated by normal AC current transmitted through the coil 204 are not sufficient to switch the nanoparticles 212, and there may be no change in magnetization. As such, minimal inductance may be exhibited by the coil 204, and the IFCL 200 will be as though it is composed of air. During fault condition, where AC current flowing through the coil 204 exceeds this normal operation range, the permeability of the core 202 will increase abruptly and a large reverse voltage limiting transmission of fault current may be generated. In the process, the IFCL 200 of the present embodiment may prevent transmission of the fault current through the IFCL 200.

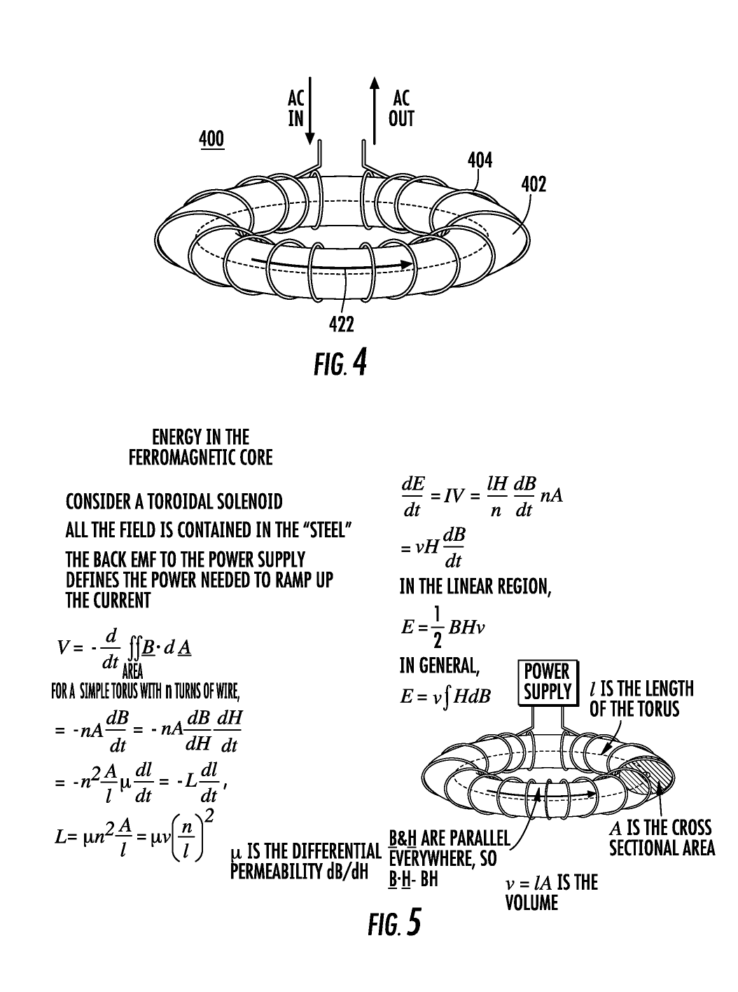

Referring to FIG. 4, there is shown another exemplary IFCL 400 according to another embodiment of the present disclosure. In the present embodiment, IFCL 400 may comprise, among others, a core 402 and a coil 404 for carrying AC current. Similar to IFCL 200 of earlier embodiment, the IFCL 400 of the present embodiment may contain additional cores (not shown) to accommodate different phases of the AC current. However, only one core is shown for clarity and simplicity. Many of the characteristics of the core 402 may be similar to the characteristics of the core 202 of the earlier embodiment. For clarity and simplicity, detailed description of such similar characteristics may be omitted.

As shown in FIG. 4, the core 402 may be a closed loop core 402, for example, a toroidal core 402. Moreover, the coil 404 may be wound around the core 402. Although not necessary, the core 402 may have a smooth, curved surface, as shown in FIG. 4. In addition, the coil 404 may optionally wound uniformly around all or substantially all of the core 402, as shown in FIG. 4. Such a coil 404 configuration may differ from that of the conventional coil 102 which is wound partially around the conventional core 102.

Similar to the core 202 of earlier embodiment, the core 402 may comprise a plurality of nanoparticles (not shown) that are too small to support domain walls. The nanoparticles may also have shape or crystal anisotropy with at least one easy axis and at least one hard axis. Such nanoparticles may be aligned and oriented such that the core 402 may have at least one easy axis illustrated with the arrow 422. In addition, the easy axis of the core 402 may be aligned with H fields generated by AC current transmitted through the coil 404. In the present embodiment, the easy axis of the core 402 may also be aligned with B fields, which are parallel to the H fields throughout the core 402.

In the present embodiment, the H fields generated by the AC current are closed, and the closed loop core 402 would require fewer turns of the coil 404. Moreover, the closed loop core 402 would produce less leakage field that might affect neighboring cores (not shown) or systems. The toroidal ferromagnetic core 402, however, may have greater mechanical complexity.

Similar to the core 202 of the earlier embodiment, the core 402 of the present embodiment may have square or substantially square hysteresis loop, the characteristic that is similar an ideal core shown in FIG. 3. To achieve such a B-H characteristic, the nanoparticles in the core 402 may preferably have uniform size, alignment, and orientation. Moreover, there may be minimal magnetic interaction among neighboring nanoparticles.

The operation of the IFCL 400 may be similar to the IFCL 200 of earlier embodiment. During normal condition, AC current transmitted through the IFCL 400 via the coil 404 experience minimal impedance as the core 404 is maintained at magnetic saturation (e.g. arrow 312 in FIG. 3). During fault condition, where AC current flowing through the coil 404 exceeds normal operation range, the core 402 may be taken out of magnetic saturation and large reducing inductance may be exhibited by the coil 204. Accordingly, transmission of the fault current through the IFCL 400 may be limited.

In the present embodiment, the toroidal core 402 illustrated in FIG. 4 may be difficult to manufacture because it requires a continuous curve in the easy direction in the material. Thus it may be convenient to approximate the toroid by a “window frame” construct in which a number of discrete linear elements are pieced together to make a closed magnetic circuit. This could be a square, a rectangle, a hexagon, or any of several closed polygons.

In the present disclosure, IFCL 200 and 400 may have several advantages. Unlike the core 102 of the conventional FCL 100, IFCL 200 and 400 of the present disclosure may not require a superconducting circuit to maintain the core 202 and 402 at magnetic saturation. Accordingly, IFCL 200 and 400 of the present disclosure need not incorporated superconducting circuit or complex cryogenic system to maintain the superconducting circuit at superconducting state. Moreover, IFCL 200 and IFCL 400 may have smaller footprint. In particular, volume of the cores 202 and 402 necessary to generate a sufficient reverse voltage to limit the fault current transmission may be less than the volume of the core 102 of the conventional IFCL 100. The volume can be understood from calculation shown in FIG. 5. Although the calculations in FIG. 5 are described with respect to the core 402 shown in FIG. 4, the calculation may be just as applicable to the core 202 shown in FIG. 2.

Referring to FIG. 5, if there are a normal root-mean-square (RMS) current Iₙ and a normal RMS voltage Vₙ, and assuming a prospective fault current can be defined by p×Iₙ, the fault current limiter 200 may preferably produce a back electromagnetic emf of the order of Vₙ so as to limit the current to q×Iₙ with q<<p. The work done on the core 302 during the first quarter phase cycle may be defined by the following equation

$$E \approx \frac{π}{2 ω} {qI}_{n} {V}_{n} \approx v \int H d B$$

where E represents as the work, ω represents angular frequency. The volume of the core 202 represented by ν may be defined by the equation:

$$v \approx \frac{π ( p - q ) {I}_{n} {V}_{n}}{2 ω \int H d B}$$

As shown in the above equation, the core 202 having nanoparticles may require less volume. Since H fields at which the nanoparticles 212 start to respond to an external field may be a function of their size and shape, H field may be engineered to be a very large value, reducing the total volume of the core 202.

TABLE 1
Total energy storage needed to limit fault currents for a range of voltages and
currents. Assuming (p-q) = 1, for a 60 Hz system,
$τ = \frac{π}{2 ω} = 42 ms and E = IV τ$

| Line Voltage, | Line current, | Energy storage needed |
|---|---|---|
| kV (rms) | A (rms) | (kJ) per phase |
| 12 | 500 | 25 |
| 33 | 1,000 | 140 |
| 138 | 2,000 | 1,200 |
| 345 | 3,000 | 4,300 |

Another factor that may influence the core volume may be the effects of hysteresis. This is a result of the irreversible nature of the magnetic moment reorientation. For a core containing silicon (e.g. silicon steel), the total energy required to of each cycle may be a very low value, about 6 mJ/kg in the longitudinal direction, and about 32 mJ/kg in the transverse direction. For the core having nano gains/crystals, the total energy in each cycle may be much greater, as much as 500 J/kg.

In the present disclosure, IFCL 200 and 400 are only required to absorb the fault energy for a limited time, until a circuit breaker can activate and switch in a high impedance air core inductor. Such circuit breakers may have a response time of 200 to 300 ms. During this time, IFCL 200 and 400 may go through up to 18 full cycles, releasing about 9 kJ/kg. The specific heat of the materials of the cores 202 and 402 may be about 0.5 J/g·° K, and the cycles may result in an increase in temperature of 18° K. Such an increase may be insufficient to have any significant effect on the properties of the cores 202 and 402, other neighboring components of IFCL 200 and 400, or other systems outside of IFCL 200 and 400.

TABLE 2
Required volume of the ferromagnetic core needed.

| | | | CoPd ferromagnetic |
|---|---|---|---|
| | | Silicon Steel | core having |
| | | (transverse) | nanograins |
| Estimated ∫HdB (J/m³) | | 100 | 500,000 |
| Volume (m³) | 12 kV | 0.3 | <0.01 |
| needed for | 33 kV | 1.4 | <0.01 |
| voltages in | 138 kV | 12 | <0.01 |
| Table 1 | 345 kV | 43 | <0.01 |

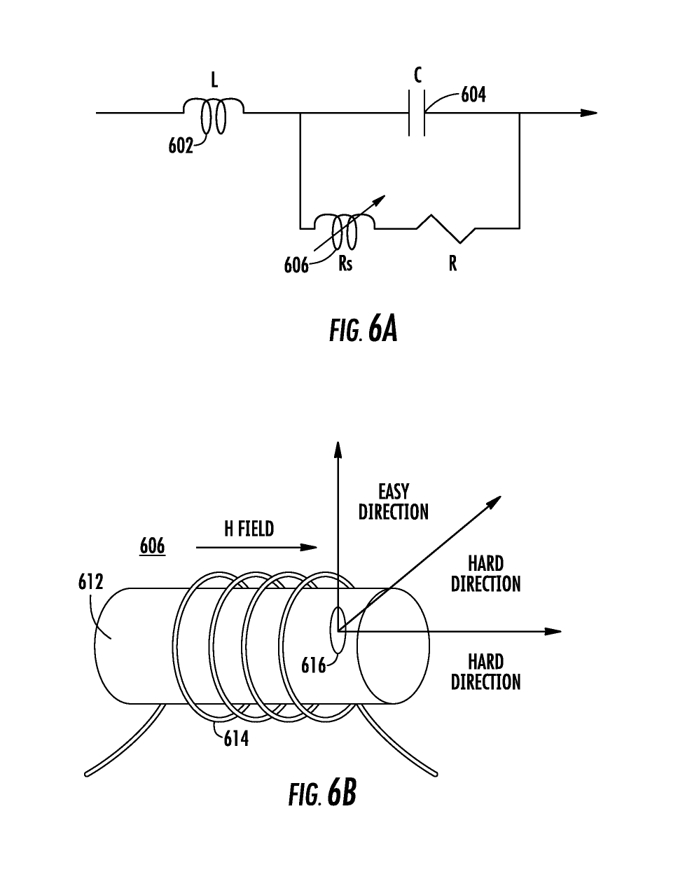

Referring to FIG. 6a, there is shown another exemplary IFCL 600 according to another embodiment of the present disclosure. In the present embodiment, LC resonant IFCL 600 is shown. As shown in the figure, the LC resonant IFCL 600 may comprise an inductor 602 and a capacitor 604 coupled in a series circuit. The LC resonant IFCL 600 may also include a resonant inductor 606 coupled in parallel to the capacitor 604. As shown in FIG. 6b, the resonant inductor 606 may comprise a core 612 and an AC coil 614 wounded around the core 612. In the present embodiment, the core 612 may have an open core configuration similar to the core 202 shown in FIG. 2. However, a closed loop configuration similar to the core 402 shown in FIG. 4 is not precluded. The core 612 and the coil 614 in the resonant inductor 606 may include many properties that are similar to those of the cores 202 and 402 and the coil 204 and 404 shown in FIGS. 2 and 4. For clarity and simplicity description of similar properties may be omitted.

Unlike the cores 202 and 402 shown in FIGS. 2 and 4, the core 612 in the resonant inductor 606 may exhibit superparamagnetic properties. The core 612 in the resonant inductor 606 may include a plurality of nanoparticles 616 having at least one easy axis. Such nanoparticles 616 may be aligned and oriented such that core 612 also have one easy axis. Unlike to cores 202 and 402 of earlier embodiment, however, the easy axis of the core 612 of the present embodiment is oriented at a right angle (90°) to the applied H field. Such a core 612 may exhibit superparamagnetic behavior with high permeability that abruptly saturates, with essentially no hysteresis, as shown in the B-H curve 702 shown in FIG. 7.

During normal operation, LC resonant IFCL 600 is tuned to the normal frequency of the power transmission system and provides low impedance. During fault condition, the resonant inductor 606 may go beyond the linear region of the permeability of the material, and the resonant frequency may suddenly change. The effective impedance may surge, and the resonant inductor 606 may limit the transmission of the fault current.

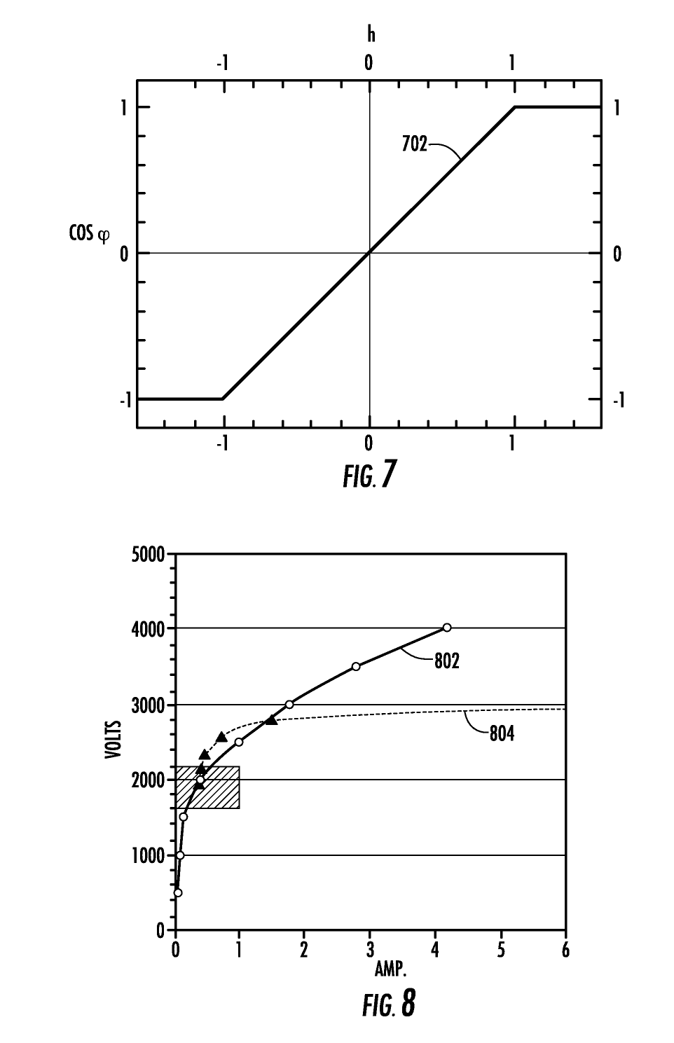

Unlike the resonant inductor in conventional LC resonant IFCL, the resonant inductor 606 of the present embodiment may minimize ferroresonance and avoid overheating. In the conventional resonant inductor, B-H characteristic of the core may saturate more gently and maintains a larger slope to higher H, as illustrated in curve 802 in FIG. 8. By contrast, the core 612 of the present embodiment exhibit very abrupt saturation, as illustrated in curve 804 of FIG. 8. LC resonant IFCL 600 of the present embodiment, using such a resonant inductor 606 may avoid the overheating and enable a LC resonant circuit IFCL 600 without ferroresonance.

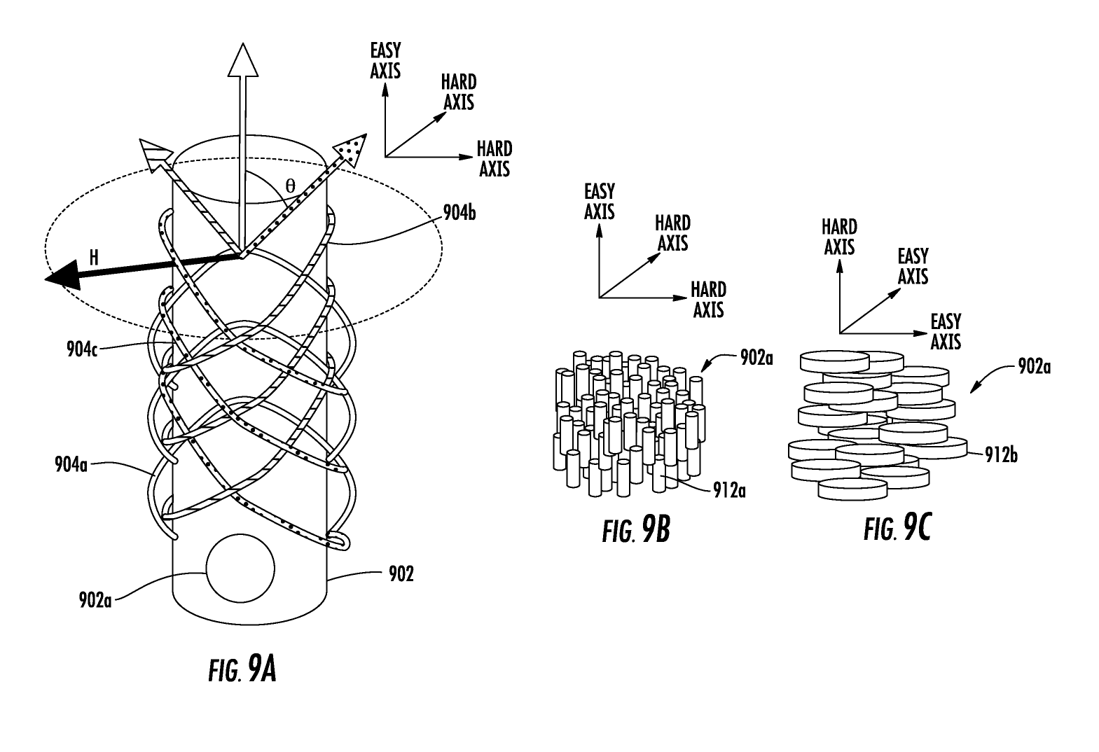

Referring to FIG. 9a, there is shown another exemplary IFCL 900 according to another embodiment of the present disclosure. In the present embodiment, IFCL 900 may be rotating moment three phase IFCL 900. As illustrated in FIG. 9a, IFCL 700 may comprise a core 902. In addition, IFCL 900 may comprise first, second, and third coils 904a, 904b, and 904c wound around the coil 902. The first to third coils 904a, 904b, and 904c may be provided to accommodate three phases of the AC current. The first to third coils 904a, 904b, and 904c are wound around the core 902 such that Hᵢ is at the same angle θ to the core axis, but rotated at 120° about that axis. If the angle θ shown in FIG. 7a is about 54°, the direction normal to each coil may be orthogonal to the other two coils.

During normal condition, total H fields (H=H₁+H₂+H₃), which may be proportional to the current in each coil 904a, 904b, and 904c, may be constant and rotate smoothly in the plane normal to the axis, as the amplitudes of H₁, H₂, and H₃ are similar to one another. However, if one of the phases experiences an excursion due to a current fault, this will force total H fields H out of the plane and will exercise the unique axis of the nanoparticles. If the nanoparticles 912a with one easy axis, as illustrated in FIG. 9b, are used, the fault current will expose the soft direction of the nanoparticles 912a, and the core 902 will introduce increased inductance to limit transmission of the fault current.

In the present embodiment, materials with nanoparticles 912a having shape or crystal anisotropy may be used as the material of the core 902. An example of nanoparticles 912a may be those having ellipsoid or cylindrical shape with one easy axis, as illustrated in FIG. 9b. Another example of such nanoparticles 912b may be those having disk shape with two easy axes, as illustrated in FIG. 9c. Those skilled in the art will recognize that if disk shape nanoparticles 912c with two easy axes are used, the core 902 shown in FIG. 9a will have two easy axes corresponding to the two easy axes of the aligned nanoparticles 912b.

Several embodiments of a novel technique for limiting transmission of fault current are disclosed. Compared to the conventional fault current limiters, IFCL of the present disclosure provides several advantages. For example, IFCL of the present disclosure may be fast acting and may be self-resetting. In addition, IFCL does not require superconducting circuit to maintain the core at saturation. As such, complex cryogenic system to maintain the superconducting circuit at low temperature may be unnecessary. The volume of the core in IFCL of the present disclosure also may be much smaller. As such, the footprint of the entire IFCL may be much smaller than conventional fault current limiter. Further several exemplary IFCL of the present disclosure may be capable of limiting transmission of fault current without generating excessive heat.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A fault current limiter comprising:
a core having at least first easy axis and a hard axis; and
a first coil wound around the core, the first coil configured to carry current.

2. The fault current limiter according to claim 1, wherein the core comprises a plurality of nanoparticles having at least first easy axis and a hard axis, wherein the at least first easy axis of the core is defined by alignment of the at least first easy axis of the plurality of nanoparticles.

3. The fault current limiter according to claim 2, wherein the plurality of nanoparticles are nano-grains having shape anisotropy.

4. The fault current limiter according to claim 3, wherein the plurality of nanoparticles have ellipsoid shape.

5. The fault current limiter according to claim 1, wherein the plurality of nanoparticles have nano-crystals having crystal anisotropy.

6. The fault current limiter according to claim 1, wherein the easy axis of the core is aligned with H fields generated by the current transmitted through the first coil.

7. The fault current limiter according to claim 1, wherein the easy axis of the core is oriented at right angle to H fields generated by the current transmitted through the first coil.

8. The fault current limiter according to claim 7, further comprising:
an inductor; and
a capacitor electrically connected to the inductor in series; and
a resistor,
wherein the coil is electrically connected to the resistor in series and wherein the coil is electrically connected to the capacitor in parallel.

9. The fault current limiter according to claim 1, wherein the core has an open end configuration.

10. The fault current limiter according to claim 1, wherein the core has a closed loop configuration.

11. The fault current limiter according to claim 10, wherein the core is a toroidal core.

12. The fault current limiter according to claim 11, wherein the coil wound uniformly around substantially entire the toroidal core.

13. The fault current limiter according to claim 1, wherein the core contains at least one of iron (Fe), silicon (Si), copper (Cu), niobium (Nb), cobalt (Co), nickel (Ni), and palladium (Pd).

14. The fault current limiter according to claim 1, further comprising:
second and third coils wound around the core, wherein each of the first, second, and third coil is perpendicular relationship with one another.

15. The fault current limiter according to claim 14, wherein the first coil is configured to carry a first AC current, wherein the second coil is configured carry a second AC current that is 120° out of phase with the first AC current, and wherein the third coil is configured to carry a third AC current that is 120° out of phase with the first and second AC current.

16. The fault current limiter according to claim 14, wherein the core further comprise a second easy axis.

17. A fault current limiter comprising:
a core comprising a plurality of nanoparticles having at least first easy axis and a hard axis, wherein the plurality of the nanoparticles are aligned to define at least first easy axis and a hard axis of the core; and
a coil wound around the core, the coil configured to transmit AC current from a first end one end of the coil to a second end of the coil,
wherein the easy axis of the core is aligned with H fields generated by the AC current transmitted through the coil and applied to the core.

18. The fault current limiter according to claim 17, wherein the core has an open end configuration.

19. The fault current limiter according to claim 17, wherein the core has a closed loop configuration.

20. The fault current limiter according to claim 17, wherein the plurality of nanoparticles are nano-grains having shape anisotropy, and wherein the plurality of nanoparticles have ellipsoid shape.

21. The fault current limiter according to claim 12, wherein the plurality of nanoparticles have nano-crystals having crystal anisotropy.

22. A method of limiting transmission of fault current, the method comprising:
transmitting current through a coil wound around a core, wherein the core exhibit at least one easy axis and a hard axis defined by alignment of plurality of nanoparticles contained therein; and
aligning the at least one easy axis of the core with H fields generated by current transmitted through the coil and applied to the core.
